(19) United States
(12) Patent Application Publication
(10) Pub. No.: US 2003/0022569 A1
(43) Pub. Date: Jan. 30, 2003

(54) Biodegradable cleansing cloth and its manufacturing processes

(76) Inventors: Hung-Hang Lee, Kaohsiung (TW); Yung-Li Hsiung, Kaohsiung City (TW)

Correspondence Address: DOUGHERTY & TROXELL, SUITE 1404, 5205 LEESBURG PIKE, FALLS CHURCH, VA, 22041, US

(21) Appl. No.: 09/910,860

(22) Filed: Jul. 24, 2001

(51) Int. Cl. B32B 3/00; B32B 9/00; B05D 3/02

(52) U.S. Cl. 442/59; 442/65; 427/385.5

(57) ABSTRACT

A biodegradable cleansing cloth and its manufacturing processes include materials, liquid polyvinyl (PVA), botanical starch, two kinds of catalysts and a fiber plate. The cleansing cloth is made through eight manufacturing processes. The first process of preparing the materials, a second process of stirring and mixing the materials except the fiber plate, a third process of coating the mixed material on the two surfaces of the fiber plate, a fourth process of heat drying and forming in a shape the work (the fiber plate with the mixed material on the two surfaces), a fifth process of foaming the work in heated water, a sixth process of washing, removing acid and cooling the work, and a seventh process of washing and compressing the work, and a last eighth process of drying again the work to become a finished biodegradable cleansing cloth.

### BACKGROUND OF THE INVENTION

This invention relates to a biodegradable cleansing cloth and its manufacturing processes, particularly to one possible to decompose to harmless substance by means of bacteria after discarded, and manufacturing processes possible to make the cleansing cloth having better quality than conventional cleansing cloth.

A first known conventional cleansing cloth is usually made of chemical substances, hardly biodegradable to make pollution to the environment, and in addition, another dry cloth has to be used to wipe off water on kitchen utensils after washing and cleansing with the first conventional cleansing cloth because of its absorbing character being not so good. In addition, the first conventional cleansing cloth is liable to be damaged even a short term of use, and has to be frequently replaced with new one, not convenient or economical.

A second known conventional cleansing cloth is made of a fiber plate having two, the upper and the lower, surfaces coated with a layer of mixed materials including a botanical starch, PVA (Polyvinyl alcohol), a first catalyst (formalin), a second catalyst (hydrochloric acid) and formed through manufacturing processes to become finished cleansing cloth. The manufacturing processes includes several ones of material preparing, of mixing and stirring the materials, of coating the liquid mixed material on two surfaces of the fiber plate, of foaming the coated mixed materials, of temperature lowering, of washing and compressing and of drying. FIG. 1 shows the foaming process in the manufacturing processes of the second conventional cleansing cloth, using a closed reaction oven, in which the fiber plate with two surfaces coated with mixed materials is sent on a conveyer net belt and receives heat added only to one surface of the fiber plate as shown by the arrow head in FIG. 1. So the result is only the upper surface of the fiber plate coated with the mixed materials produces enough foaming and the lower surface of the fiber plate receives insufficient heat to produce uneven foaming. Thus the coated mixed materials on the lower surface of the fiber plate may easily adhere to the conveyer net belt, resulting in bad quality of the finished cleansing cloth and extra work in cleaning the conveyer net belt. In addition, when the fiber plate enters the reaction oven for receiving heat foaming, the mixed materials coated on the two surfaces of the fiber plate are still in liquid state, so the mixed material may be liable to flow around to cause uneven coating of the mixed materials, resulting in different thickness of the two layers of the mixed materials on the two surfaces of the fiber plate. Moreover, the temperature in the reacting oven for foaming is more than 350° C., causing the structure of the fiber plate damaged or twisted to become unqualified products.

### SUMMARY OF THE INVENTION

This invention has the objective of supplying a biodegradable cleansing cloth having strong cleansing force, and capable to decompose after discarded, and its manufacturing processes. The feature of the manufacturing processes include an important characteristics of a water foaming process to take place of the heat foaming process in the second conventional manufacturing processes after a work (i.e. a fiber plate having two surfaces coated with the mixed materials) is in advance heated to let the liquid mixed materials initially harden a little for not attaching to the conveyer net belt. The rest processes of the invention are almost the same as those in the second conventional manufacturing processes for a cleansing cloth. In the water foaming process, the temperature and the time for foaming are two important elements for produce foaming of the mixed materials to produce a strong structure with very porous condition. Then the finished cleansing cloth may have excellent quality and strong cleansing force, in addition to the biodegradable characteristic. And if necessary, the two surfaces coated with hardened mixed materials may be ground by a grinding device to make the two surfaces more delicate, flat and soft to touch, elevating additional value and widening usage of the cleansing cloth.

### BRIEF DESCRIPTION OF DRAWINGS

This invention will be better understood by referring to the accompanying drawings, wherein:

FIG. 1 is a side cross-sectional view of a foaming process included in second conventional manufacturing processes for a cleansing cloth;

FIG. 2 is a list of materials for manufacturing a cleansing cloth in the present invention;

FIG. 3 is a block diagram of flowing manufacturing processes for the cleansing cloth in the present invention;

FIG. 4 is a side simple view of the manufacturing processes of the cleansing cloth in the present invention;

FIG. 5 is a side cross-sectional view of the irregular surface of the cleansing cloth in the present invention;;

FIG. 6 is a side view of delicate surfaces of the cleansing cloth in the present invention; and,

FIG. 7 is a perspective view of another embodiment of the foaming process in the present invention.

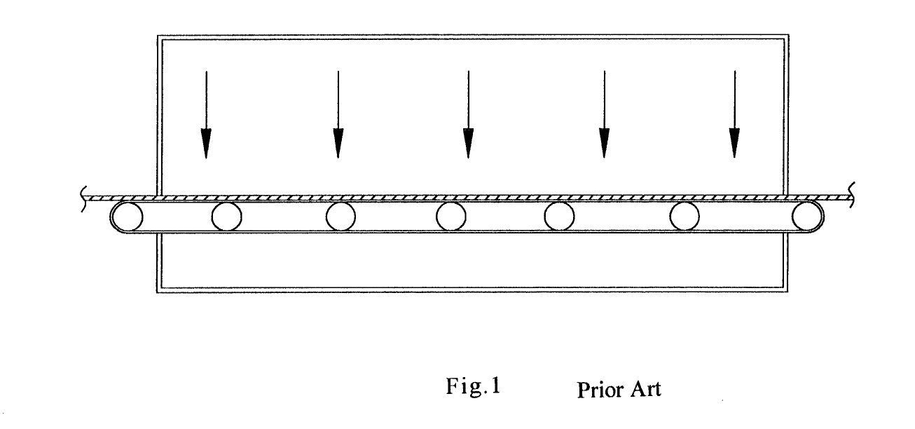

### DETAILED DESCRIPTION OF THE PREFERRED EMBODIMENT

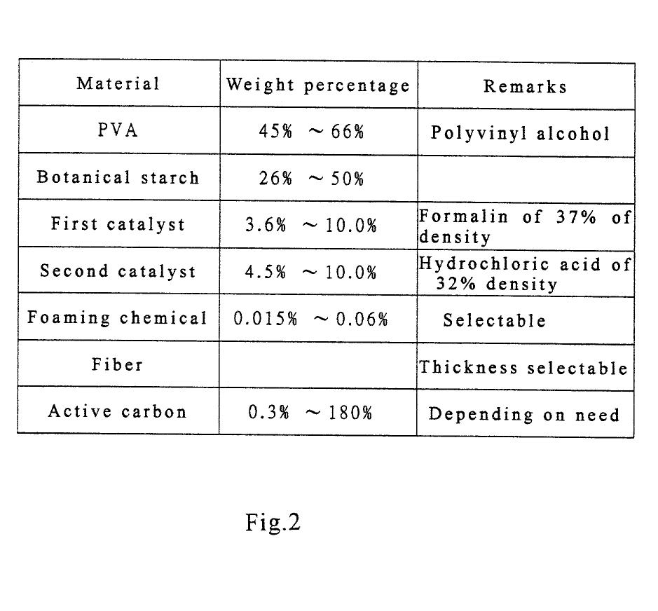

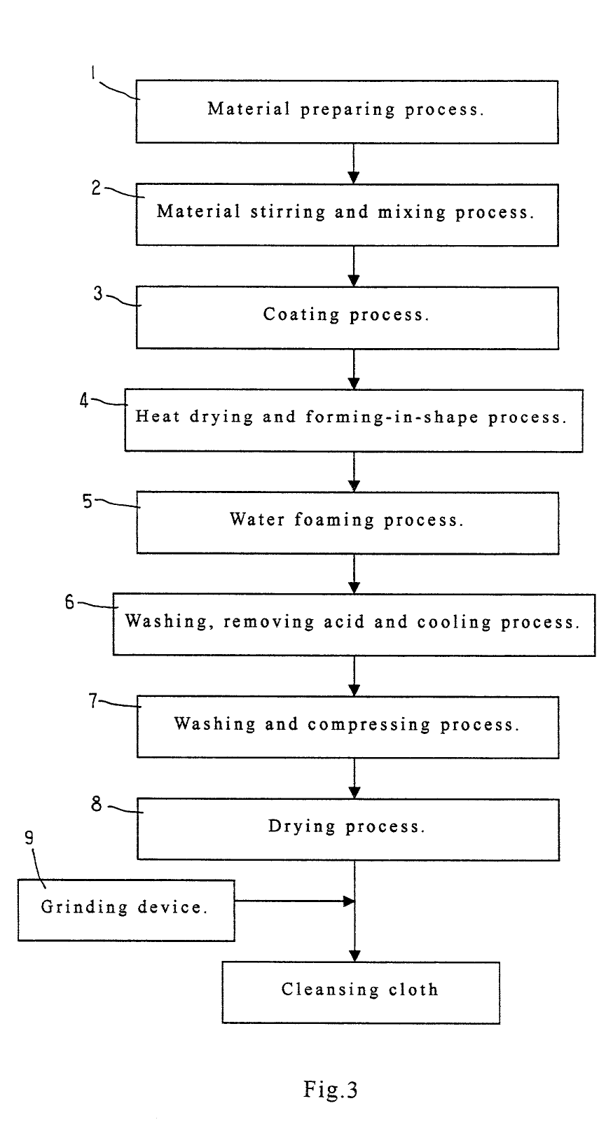

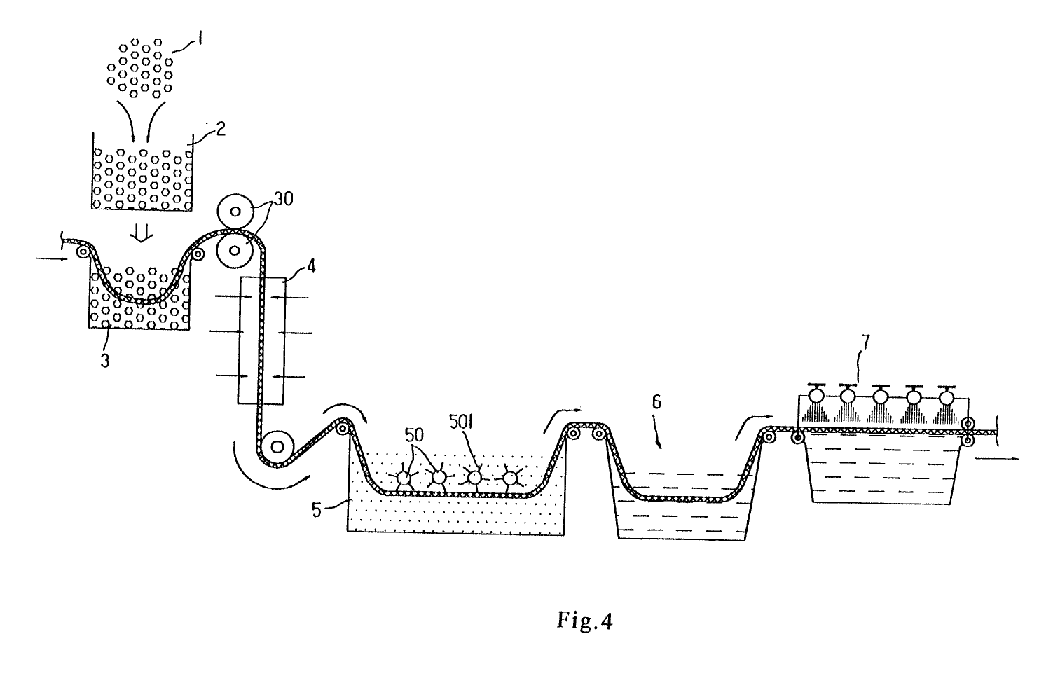

A preferred embodiment of a cleansing cloth and its manufacturing processes are shown in FIGS. 2, 3 and 4, including necessary materials for the cleaning cloth and auxiliary chemicals for foaming reaction process included in the manufacturing processes.

First, the manufacturing processes include eight processes to be described below.

A first process is to prepare necessary materials including a first material, 45%-66% in weight of polyvinyl alcohol (PVA, BF-17, ratio of PVA and water being more than 1:5), a second material, 26%-50% in weight of botanical starch (ratio of starch and water being more than 1:5), a third material, 3.6%-10% in weight of a first catalyst (formalin), a fourth material, 4.5%-10% in weight of a second catalyst (hydrochloride acid) and a fifth material, a long natural fiber plate.

A second process is to mix and stir the first material PVA with water and heated and stirred at the same time to a non-grain condition and then lowered in its temperature to become a material (A), and then the second material, the botanical starch, is mixed with water, stirred to a paste condition, and then lowered in its temperature to become a material (B). Then the material (B) is mixed with the fourth material (hydrochloric acid) and stirred to become a mixed material (C), and the material (A) and the mixed material (C) are mixed together to become a mixed material (D). Then the mixed material (D) is added and stirred with the third material (formalin) to become a saturated mixed material, and finally a proper volume of active carbon is added in the saturated mixed material to become a mixed material (E), depending on selection or necessity.

A third process is to coat the saturated missed material or the mixed material (E) on two surfaces of a long fiber plate moved on the conveyer net belt, and the thickness of the fiber plate is selectable.

A fourth process is to dry with heat and initially harden the work (the fiber plate with the mixed material (E) coming out of the third process by means of a heating device adjustable in its temperature. The heating source of the heating device may be infrared ray, microwave or a nichrome wire. Then the saturated mixed material or the mixed material (E) coated on the two surfaces of the fiber plate are kept stable, not moving around, or resolving in the water in a water tank used in a fifth process when the work enters the fifth process, or remaining or attaching on the conveyor net belt. Further, the heating device has the heat sources facing the two surfaces of the fiber plate so the work may never scorch or disfigure owing to uneven heating condition.

Next, a fifth process is water foaming of the work finishing the fourth process, by using a reaction water tank, in which the work moves by means of the conveyor net belt, passing through heated water with temperature 90° C.-110° C. plus the second catalyst, 8%-12% in weight of hydrochloric acid, and the first catalyst, 8%-12% in weight of formalin resolved therein. As the water in the reacting water tank has some buoyancy, so the saturated mixed material coated on the two surfaces of the fiber plate are not affected by gravity, completely attached evenly on the two surfaces of the fiber plate with the same thickness. In addition, guide rollers 50 are fixed in the reaction water tank for pressing and guiding the work, preventing the work from floating up, and a plurality, preferably 4 or 5, of pushing needles 501 are attached around each guiding roller 50 to keep the work from both floating and the saturated mixed material from separating from the fiber plate so as to hold good quality of finished products. Further, the length of the reaction water tank and moving speed of the work in the tank can be adjusted according to necessity. Function of the water foaming is to permit the material (A) and the material (C) produce bridging and linking between them sufficiently and capable to repulse water so that finished cleansing cloth may have strong structure filled with many tiny air holes. The water temporarily stored in the air holes is to be removed by a seventh process to be described later.

Next, the sixth process is to wash, remove acid and cool the work finishing the fifth process, by moving the work through a water tank to lower its temperature and initially removing the first and the second catalyst containing acid from the work, which then becomes an initial cleansing cloth product.

Next, a seventh process is to wash again and compress the initial cleansing cloth coming out of the sixth process, in particular, washing the work completely to make it neutral, and compressing it to remove water remaining in the many air holes in the initial cleansing cloth so that the initial cleansing cloth may have strong water absorbing force by means of existence of the many air holes and absorbing property of the materials themselves.

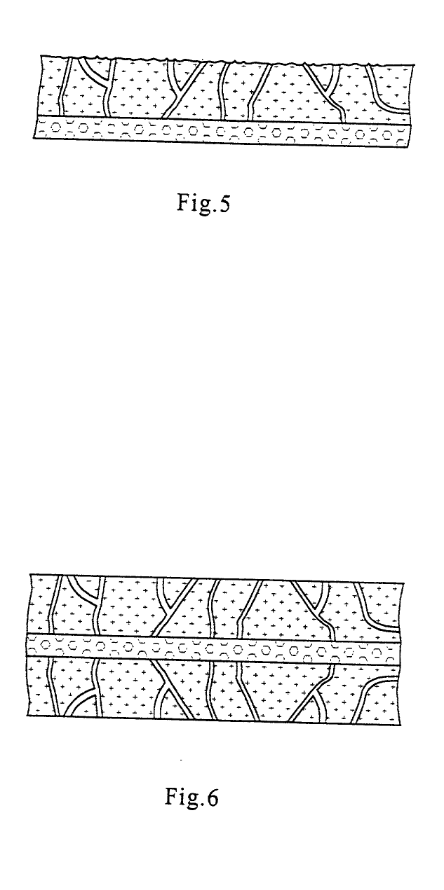

Lastly, an eighth process is to dry again the initial cleansing cloth completely to become a finished cleansing cloth with good water absorbing property, fine stability and strong structure, as shown in FIG. 5.

Besides, a squeezing device 30 may be additionally provided after the third process of coating the saturated mixed material or the mixed material (E) on the two surfaces of the fiber plate, smoothing irregular two surfaces of the materials coated thereon for initially forming the shape of the work.

Further, in order to make the cleansing cloth in the invention also applicable to wipe a human body, a smoothing compress step may be added in the seventh process to smooth the two surfaces of the cleansing cloth more delicate, flat and soft for touching a human body. Further, a grinding device 9 may be provided after the last eighth process for grinding the two surfaces of the cleansing cloth much more delicate, flat and soft, as shown in FIG. 6. Or an extra wiping member may be added respectively on the two surfaces of the cleansing cloth to strengthen wiping function, elevating worthiness and broadening usage of the cleansing cloth.

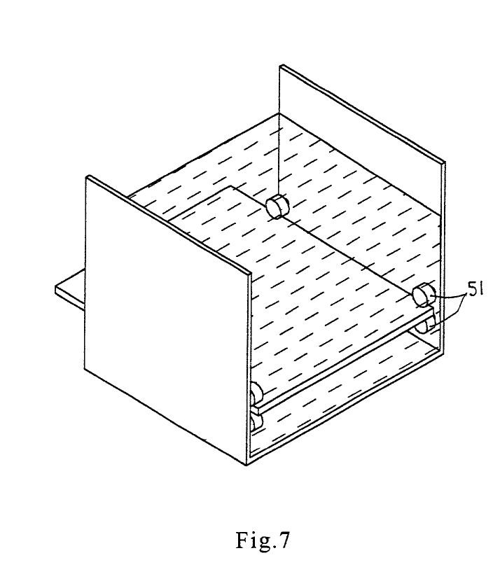

Besides, FIG. 7 shows another embodiment of the fifth process of water foaming, utilizing pinching members 51 provided in the reaction water tank for pressing and guiding the work, keeping the work from floating up therein and preventing the materials from remaining or attaching on the conveyor net belt.

Further, it has to be emphasized that 0.3%-180% in weight of active carbon has to be added in the saturated mixed materials after the second process is finished. Thus active carbon can have strong attaching force and function to adhere around a substance. Provided that active carbon should be added in the materials during stirring and mixing them, active carbon might be certain to attach the paste botanical starch and be surrounded by it, preventing many air holes from communicating with outer open air, losing water absorbing and odor removing function it should have. The manufacturing processes in the invention have improved the conventional manufacturing ones, which only spray active carbon on the surfaces of a cleansing cloth, with active carbon impossible to adhere firmly thereon and liable to fall off in touching or washing.

Besides, 0.015%-0.06% in weight of foaming chemical may be added in the fifth process of foaming in the manufacturing processes in the invention, in order to make the finished cleansing cloth have the structure of comparatively slack and porous with a large number of a bit larger air holes, but not of a honeycomb condition.

As can be understood from the aforesaid description, the biodegradable cleansing cloth and its manufacturing processes in the invention have the following advantages.

1. The cleansing cloth may be applied for cleansing or absorbing, and for insole substitutes, gas masks or filters, if active carbon is added therein.

2. The cleansing cloth has extremely strong absorbing function, and large cleansing force, so it is easy to wash and dry, and improved to have better quality than the conventional cleansing cloth.

3. The fifth manufacturing process of water foaming has an effect of not leaving or attaching materials on the conveyor net belt, lessening labor and time for cleaning the conveyor net belt.

4. The two surfaces of the cleansing cloth can be smoothed by means of the flat compressing added in the seventh process of washing and compressing, or by means of the grinding device provided after the last drying process so that the surfaces of the cleansing cloth may become more delicate, flat and soft so as to be usable for wiping a human body and face, with worthiness of the cleansing cloth elevated and widened in its usage.

While the preferred embodiment of the invention has been described above, it will be recognized and understood that various modifications may be made therein and the appended claims are intended to cover all such modifications that may fall within the spirit and scope of the invention.

What is claimed is:

1. Manufacturing processes for biodegradable cleansing cloth orderly comprising:
A first process of preparing materials for manufacturing said biodegradable cleansing cloth, said materials including a first material, polyvinyl alcohol (PVA) added with water and then heated and stirred at the same time to have a non-grain condition, a second material, botanical starch added with water and then heated and stirred at the same time to become a hot paste condition, and then cooled to room temperature, a third material of a first catalyst, a fourth material of a second catalyst, and a fifth material, a fiber plate;
A second process of stirring and mixing sufficiently said second material, the paste starch, and said third material of the first catalyst to become a first mixed material, said first mixed material mixed with said PVA and water and then said fourth material, the second catalyst, and then stirred completely to become a saturated mixed material;
A third process of coating evenly said saturated mixed material on an upper and a lower surface of said fiber plate;
A fourth process of heat drying and hardening initially into a shape said fiber plate with the two surfaces coated with said saturated mixed material;
A fifth process of water foaming said saturated mixed material to force said various materials contained in said saturated mixed material produce bridging and linking function sufficiently and water repulsing function so that the saturated mixed material may have a strong and porous structure;
A sixth process of washing said fiber plate with said foamed saturated mixed material, removing initially acid contained in said first catalyst and said second catalyst, and cooling said fiber plate with the foamed saturated mixed material after washing;
A seventh process of washing and compressing to neutralize said fiber plate with said washed saturated mixed material and compressing to remove water remained in many air holes produced therein after said fifth process,
An eighth process of drying again the fiber plate with said washed and foamed saturated mixed material to become finished cleansing cloth with many comparatively big air holes, good stability and strong structure; and,
Characterized by said fourth process added with a heating device with its temperature adjustable, said heating device having heat sources facing the two surfaces of said fiber plate, said fifth process of foaming including a reaction water tank wherein foaming occurs to the coated saturated mixed material within water stored therein, temperature of said reaction water tank adjustable for necessary foaming according to different demands, length of said reaction water tank and moving speed of said fiber plate with said foamed saturated mixed material on the two surfaces also adjustable according to different demands.

2. The manufacturing processes for biodegradable cleansing cloth as claimed in claim 1, wherein said reaction water tank has heated water of 90° C.-110° C. therein.

3. The manufacturing processes for biodegradable cleansing cloth as claimed in claim 1, wherein 0.3%-180% in aggregate weight of active carbon is added in said saturated mixed material after said second process of stirring and mixing the materials.

4. The manufacturing processes for biodegradable cleansing cloth as claimed in claim 1, wherein 0.015%-0.06% in aggregate weight of foaming chemical is added in said saturated mixed material in said fifth process of foaming.

5. The manufacturing processes for biodegradable cleansing cloth as claimed in claim 1, wherein a plurality of guide rollers are provided in said reaction water tank.

6. The manufacturing processes for biodegradable cleansing cloth as claimed in claim 5, wherein said guide rollers respectively have a plurality of pushing needles spaced around an outer surface thereof.

7. The manufacturing processes for biodegradable cleansing cloth as claimed in claim 1, wherein said reaction water tank is provided with a plurality of pinching members for said fiber plate.

8. The manufacturing processes for biodegradable cleansing cloth as claimed in claim 1, wherein a catalyst mixed in the water in said reaction water tank is hydrochloric acid.

9. The manufacturing processes for biodegradable cleansing cloth as claimed in claim 1, wherein a catalyst mixed in the water in said reaction water tank is formalin.

10. The manufacturing processes for biodegradable cleansing cloth as claimed in claim 1, wherein said third process additionally uses a plurality of squeezing rollers.

11. A biodegradable cleansing cloth comprising:
A fiber plate:
A wiping member respectively coated on an upper and a lower surface of said fiber plate;
Said wiping member made of 45%-66% in weight of polyvinyl alcohol in a non-grain condition, 26%-50% in weight of botanical starch in paste condition, 4.5%-10.0% in weight of a first catalyst of hydrochloric acid of 32% density, 3.6%-10.0% in weight of a second catalyst of formalin of 37% density, and 0.015%-0.06% in aggregate weight of foaming chemical, said wiping members having a porous structure, and characterized by mixed materials of said wiping members being evenly coated on the two surfaces of said fiber plate, said cleansing cloth being washed and compressed flat by a washing and compressing device so that said cleansing cloth has said two surfaces delicate, flat and soft.

12. The biodegradable cleansing cloth as claimed in claim 11, wherein said fiber plate has the two surfaces ground by a grinding device after formed in a shape so as to have the two surfaces more delicate, and glossy.
